(19) United States
(12) Patent Application Publication
(10) Pub. No.: US 2008/0223035 A1
(43) Pub. Date: Sep. 18, 2008

(54) Brake Fluid Valve Assembly

(75) Inventors: Phillip J. Smith, West Midlands (GB); Michael McKeon, Leicestershire (GB)

Correspondence Address: BARNES & THORNBURG LLP, P.O. BOX 2786, CHICAGO, IL, 60690-2786, US

(73) Assignee: ALCON COMPONENTS LIMITED, Staffordshire (GB)

(21) Appl. No.: 11/997,138

(22) PCT Filed: Jul. 31, 2006
(86) PCT No.: PCT/GB06/02846

§ 371 Date: Mar. 24, 2008

(30) Foreign Application Priority Data
Jul. 29, 2005 (GB) 0515617.9

(51) Int. Cl. B60T 17/04; F16D 65/74

(52) U.S. Cl. 60/591; 303/28

(57) ABSTRACT

The present invention relates to a brake fluid valve assembly (12). Assembly (12) comprises a housing (14) defining an inner chamber (21). A first non-return valve (32) and a second non-return valve (33) are arranged in the chamber (21). The housing (14) defines an inlet (22) and outlets (23, 24). Assembly (12) also comprises feed port means (34) arranged to allow fluid to flow from the inlet (22) to the first non-return valve (32). The first non-return valve (32) is arranged to let fluid flow from a master cylinder (11) through the inlet (22) and through the outlets (23, 24) towards a caliper (1) to apply a brake. Return port means (50) are arranged to allow fluid to flow from the outlets (23, 24) to the second non-return valve (33). The second non-return valve (33) is arranged to let fluid flow from a caliper through the outlets (23, 24) and through the inlet (22) towards a master cylinder (11). The assembly also comprises a restrictor port (52) between the outlet and the second non-return valve. The restrictor port (52) is arranged to allow fluid to by-pass the second non-return valve, and restrict the flow of fluid from a caliper through the outlet and through the inlet towards a master cylinder when brake fluid pressure drops below a predetermined value.

The present invention relates to a brake fluid valve assembly.

Brake ‘knock-off’ is a common problem in vehicles fitted with disc brakes that incorporate fixed opposed piston calipers and is described as follows.

Brake systems for high performance vehicles or racing cars are designed to include clearances to prevent off-brake drag and, under normal road use, the designated clearances are maintained. Due to the specified clearances, there is a small amount of dead pedal travel when the brake pedal is pressed before pressure starts to build as fluid is transferred from the master cylinder to the brake caliper. However, under hard use, such as on a racetrack, the wheel, hub and wheel bearing can deflect during cornering or when driving over rumble strips or kerbing. Since the caliper is rigidly mounted to the upright/knuckle, component deflection causes the disc to push the brake pad in the direction of the caliper pistons, displacing the pistons into the caliper bore and forcing an amount of fluid back to the master cylinder. When the brake pedal is re-applied, dead pedal travel is greater due to the increased volume of fluid required to be transferred from the master cylinder to the caliper to push the pistons forwards against the pads. In severe cases, the total available pedal travel is insufficient to push the pistons forwards and the pedal must be pumped. During this action, no brake pressure is generated and the vehicle does not decelerate, to which there can be serious safety repercussions.

One recognised solution to this problem is to fit a spring behind each piston to push the piston against the pad. However, the spring load required to prevent pistons being pushed into the caliper bore can lead to a force being applied to the pad, with the consequence that the brake is continually applied, which leads to overheating of the brake.

An aim of the invention is to provide an alternative brake fluid valve assembly.

According to one aspect of the invention there is provided a brake fluid valve assembly comprising a first fluid flow path means and a second fluid flow path means, each fluid flow path means for allowing brake fluid to flow in a direction from a caliper towards a master cylinder, the second fluid flow path means defining a minimum cross sectional area which is smaller than the minimum cross sectional area of the first fluid flow path means, the assembly being configured so that when brake fluid pressure is above a predetermined value, fluid can pass along the first fluid flow path means, and when brake fluid pressure drops below the predetermined value, the first fluid flow path means is arranged to close and fluid can pass only along the second fluid flow path, so as to restrict the maximum possible flow rate of fluid in a direction from a caliper towards a master cylinder.

When the brake fluid pressure is above the predetermined value, the second fluid flow path means is preferably part of the first fluid flow path means.

The first fluid flow path means may comprise a plurality of paths for ducting fluid in parallel.

One path of the first fluid flow path means may have a different minimum cross sectional area from another path of the first fluid flow path means. One path of the first fluid flow path means may have the same minimum cross sectional area as another path of the first fluid flow path means. All of the paths of the first fluid flow path means may have the same minimum cross sectional area.

At least one of the paths of the first fluid flow path may have a larger minimum cross sectional area than the minimum cross sectional area of the second fluid flow path. A plurality of the paths of the first fluid flow path may have a larger minimum cross sectional area than the minimum cross sectional area of the second fluid flow path. Each of the paths may have a larger minimum cross sectional area than the minimum cross sectional area of the second fluid flow path.

At least one of the paths may have a smaller minimum cross sectional area than the minimum cross sectional area of the second fluid flow path. A plurality of the paths may have a smaller minimum cross sectional area than the minimum cross sectional area of the second fluid flow path. Each of the paths may have a smaller minimum cross sectional area than the minimum cross sectional area of the second fluid flow path.

At least one of the paths may have the same minimum cross sectional area as the minimum cross sectional area of the second fluid flow path. A plurality of the paths may have the same minimum cross sectional area as the minimum cross sectional area of the second fluid flow path. Each of the paths may have the same minimum cross sectional area as the minimum cross sectional area of the second fluid flow path.

The second fluid flow path means may comprise a plurality of paths. Alternatively, the second fluid flow path means may comprise a single path.

The first fluid flow path means may be arranged so that, above the pre-determined pressure, at least part of the fluid flowing therethrough is unchoked. Below the pre-determined pressure, the second fluid flow path may be arranged so that at least part of the fluid flowing therethrough is choked.

Preferably, the assembly comprises a non-return valve which defines the first fluid flow path. The non-return valve may also define the second fluid flow path. Alternatively, the second fluid flow path having the second area is arranged to allow fluid to by-pass the non-return valve and therefore the first fluid flow path.

The first fluid flow path is preferably arranged to close when brake fluid pressure is between 0 and 6 bar. In one preferred embodiment, the first fluid flow path is arranged to close when brake fluid pressure drops below a pressure of about three bar. In another preferred embodiment, the first fluid flow path is arranged to close when brake fluid pressure drops below a pressure of about two bar.

The size of the minimum area of the second fluid flow path may be variable. In such a case, the second fluid flow path comprises a needle valve arranged to vary its size.

The second fluid flow path preferably comprises a restrictor port. However, the second fluid flow path may comprise a plurality of restrictor ports. Preferably, the first fluid flow path comprises a plurality of return ports. Preferably, at least one return port has a restrictor port associated with it. Alternatively, each return port has a restrictor port associated with it.

The assembly preferably comprises a second non-return valve for letting fluid flow from a master cylinder towards a caliper to apply a brake.

Preferably, the assembly comprises a housing defining an inner chamber, the first non-return valve and the second non-return valve being arranged in the chamber, the housing defining an inlet and an outlet.

Preferably, the assembly comprises at least one restrictor port arranged between the outlet and the second non-return valve.

Preferably, the assembly comprises a single restrictor port arranged between the outlet and the second non-return valve.

Preferably, the assembly comprises a return port arranged to allow fluid to flow from the outlet to the second non-return valve.

Preferably, the assembly comprises a plurality of return ports arranged to allow fluid to flow from the outlet to the first non-return valve.

Preferably, wherein the assembly comprises a plurality of feed ports arranged to allow fluid to flow from the inlet to the second non-return valve.

Preferably, the assembly comprises a restrictor port being arranged (circumferentially) between two feed ports.

The assembly may comprise a restrictor port arranged midway between two feed ports.

The brake fluid valve assembly may be enclosed in a capsule.

According to a second aspect of the invention there is provided a master cylinder comprising a brake fluid valve assembly according to the first aspect of the invention or any of the consistory clauses relating thereto.

According to a third aspect of the invention there is provided a brake caliper comprising a brake fluid valve assembly according to the first aspect of the invention or any of the consistory clauses relating thereto.

According to a fourth aspect of the invention there is provided a brake fluid control circuit comprising a brake fluid valve assembly according to the first aspect of the invention or any of the consistory clauses relating thereto.

According to a fifth aspect of the invention there is provided a vehicle comprising a brake fluid valve assembly, master cylinder, brake caliper or circuit according to the first aspect of the invention or any of the consistory clauses relating thereto, or the second, third or fourth aspect of the invention.

A brake fluid valve assembly in accordance with the invention will now be described, by way of example only, and with reference to the accompanying drawings, in which:

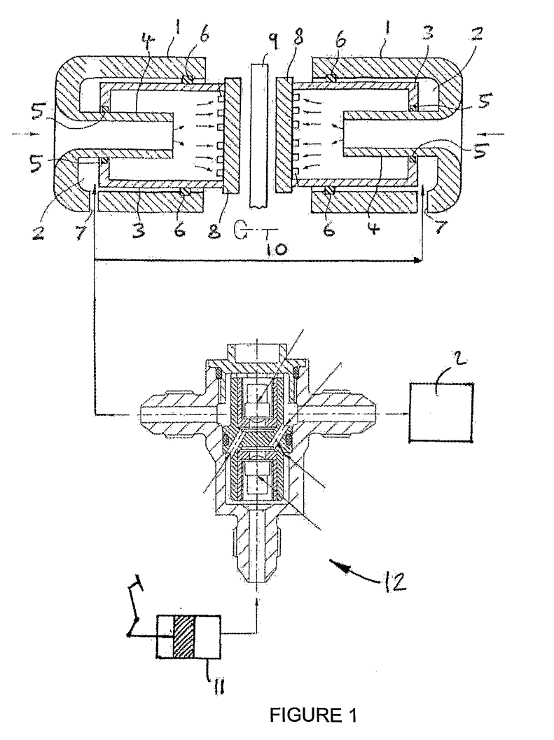

FIG. 1 is a schematic representation, mainly in cross section, of part of a brake fluid circuit in accordance with a first embodiment of the invention,

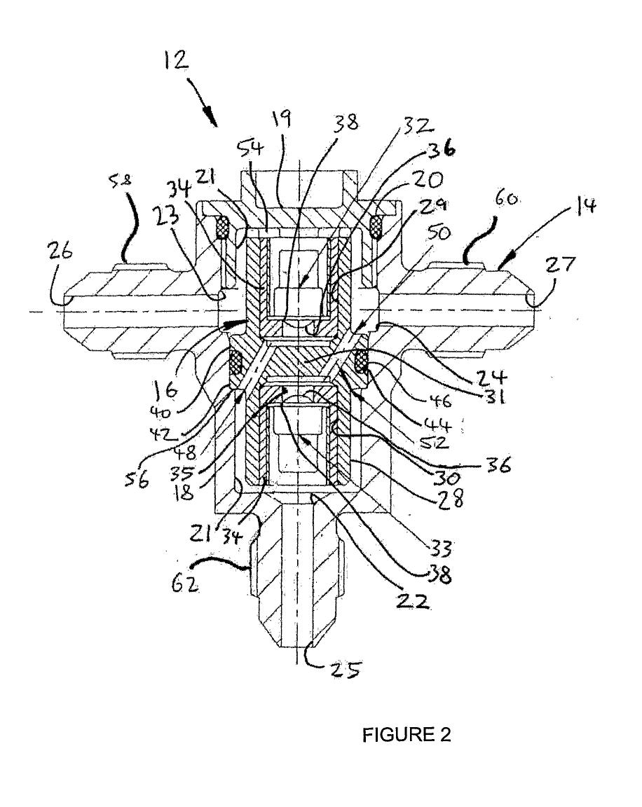

FIG. 2 is an expanded view, again in cross section, of a brake fluid valve assembly in the brake fluid circuit of FIG. 1,

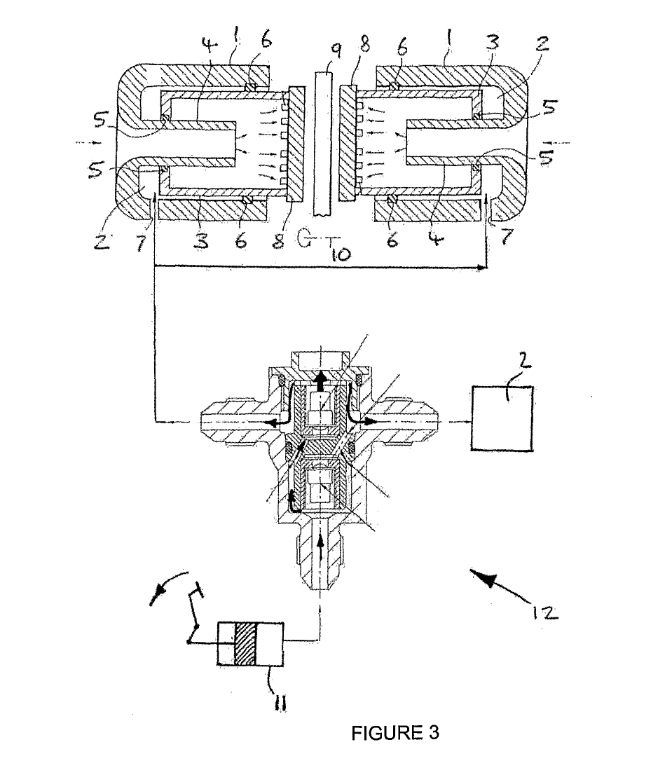

FIG. 3 is the brake fluid circuit of FIG. 1, when a driver is depressing a brake pedal of a vehicle,

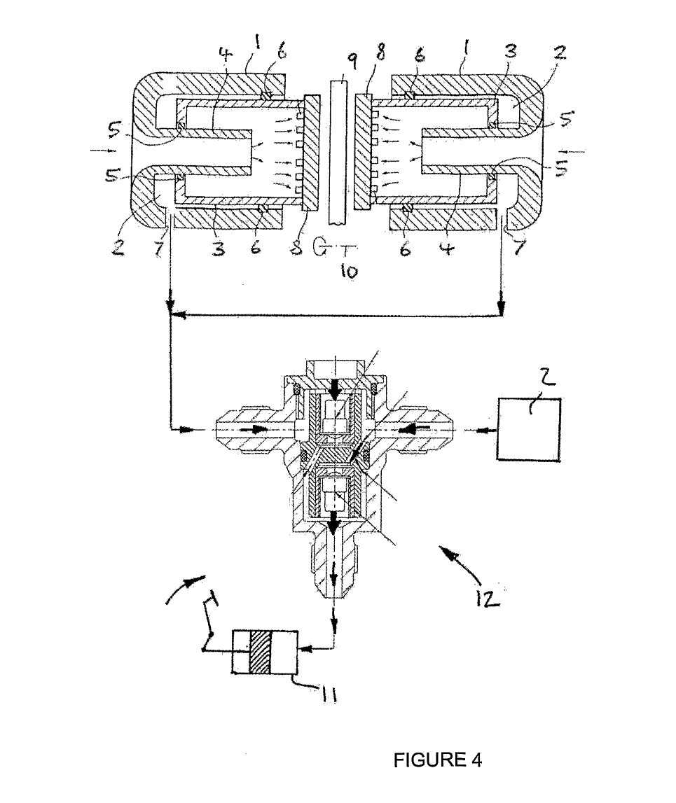

FIG. 4 is the brake fluid circuit of FIG. 1, when a driver releases the brake pedal,

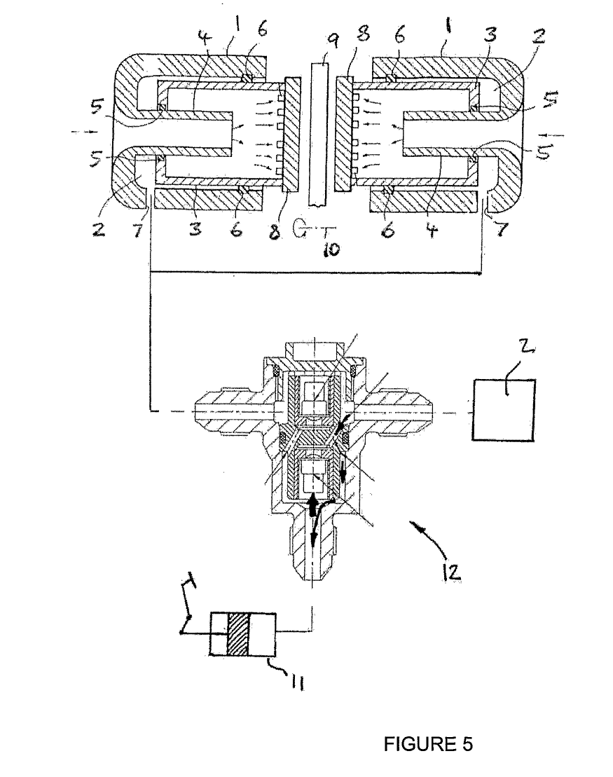

FIG. 5 is the brake fluid circuit of FIG. 1, showing a path that the brake fluid takes when the pressure of the fluid has decayed to a pre-determined value,

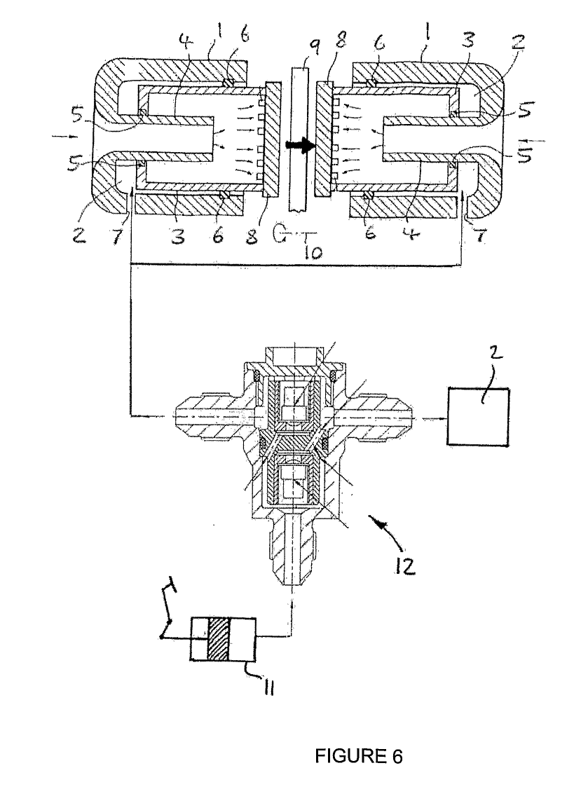

FIG. 6 is the brake fluid circuit of FIG. 1, when a “knock-off” event occurs,

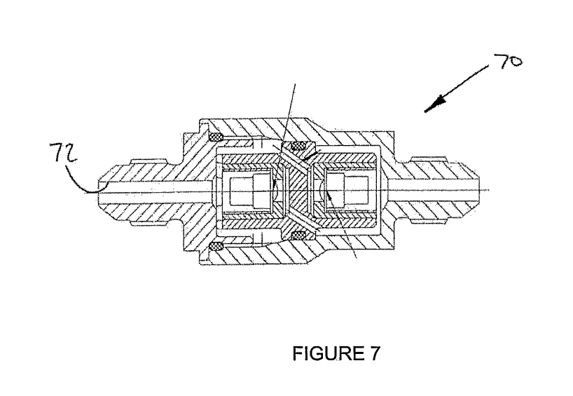

FIG. 7 is a schematic cross section of another brake fluid valve assembly in accordance with a second embodiment of the invention,

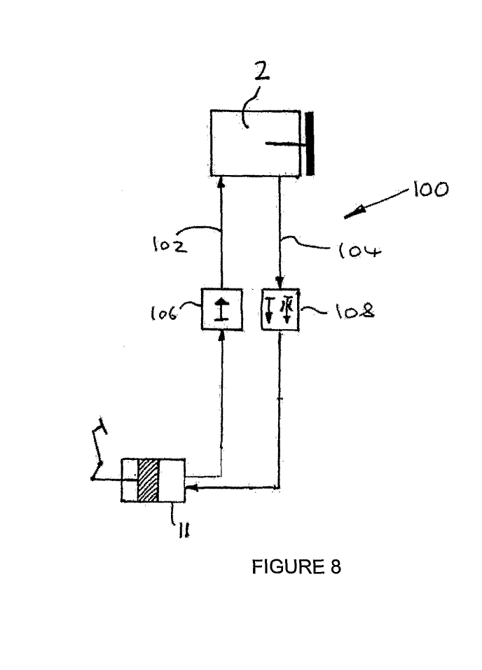

FIG. 8 is a schematic view of a brake fluid valve assembly in accordance with a third embodiment of the invention, and

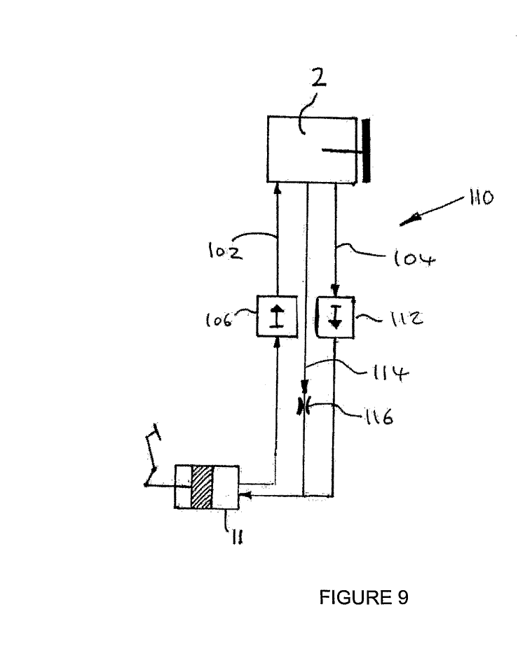

FIG. 9 is a schematic view of another brake fluid valve assembly in accordance with a fourth embodiment of the invention.

Referring to FIG. 1, a standard brake fluid circuit comprises a brake caliper 1, a master cylinder 11, actuable by a brake pedal, and a brake fluid line therebetween, flow of brake fluid being governed by a suitable valve assembly arranged along the brake fluid line.

The brake caliper 1 straddles part of a brake disc 9. The brake caliper 1 defines a plurality of cylindrical bores 2 and each bore 2 houses a cylindrical piston 3. Chimney-like flow through devices 4, extend from the base of each piston bore 2, parallel to the wall of the bore, and continue through the base of the associated piston 3. Seals 5 are arranged between each flow through device 4 and the base of each piston 3.

Further seals 6 are arranged between an open end of each bore 2 and a free end of the associated piston 3. The caliper 1 comprises inlets 7 which allow brake fluid to enter the bores 2 between the caliper 1 and the associated piston 3. Each piston 3 acts on a brake pad 8, which is arranged to move into contact with a brake disc 9 which moves about an axis of rotation 10 corresponding to the centre of a vehicle wheel (not shown).

The master cylinder 11, actuated by a brake pedal, moves a body of brake fluid, and thereby controls the pressure of the brake fluid flowing through the inlets 7 into the bores 2 of the calipers 1 and hence the braking force applied to the discs 9.

Still referring to FIG. 1, and in accordance with the invention, a brake fluid valve assembly 12 is arranged between the master cylinder 11 and the caliper 1. The brake fluid valve assembly 12 is in the form of a T-shaped capsule.

Referring to FIG. 2, the brake fluid valve assembly 12 comprises a hollow housing 14 and a valve cartridge 16 therein.

The housing 14 is formed in two parts, a T-shaped housing part 18 and a cap part 19. The cap part 19 is secured to the housing part 18 by a screw threaded engagement. A sealing O-ring 20 is arranged between the housing part 18 and the cap part 19.

The T-shaped housing part 18 defines an inner chamber 21 which has a chamber inlet 22, a first chamber outlet 23 and a second chamber outlet 24. The chamber inlet 22, first chamber outlet 23 and second chamber outlet 24 are in fluid communication with respectively, a housing inlet 25, a first housing outlet 26 and a second housing outlet 27, through hollow branches of the T-shaped housing part 18.

The valve cartridge 16 comprises a tubular part 28, divided into two cup-like parts 29 and 30 by a solid central part 31. The tubular part 28 comprises a first (brake on) non-return valve 32 and a second (brake off) non-return valve 33. Each non-return valve 32, 33 comprises a cup-like housing 34, which corresponds in shape to the cup-like parts 29 and 30. Each cup-like housing 34 has an aperture 35 in its base and a ball 36 is spring biased against a seat 38 surrounding the aperture 35. The non-return valves 32, 33 are arranged in back-to-back manner in the cup-like parts 29 and 30.

An outer surface of the tubular part 28 has a first annular wall 40 and a second annular wall 42 and a recess 44 between them, half way along the length of the tubular part. A second sealing O-ring 46 is arranged in the recess 44.

The tubular part 28 comprises a first feed port 48, a second feed port, a third feed port and a fourth feed port (only the first of which is shown). The feed ports are arranged at 90 degree intervals.

The tubular part 28 also comprises a first return port 50, a second return port, a third return port, and a fourth return port, (only the first of which is shown). The return ports 50 are also spaced at 90 degree intervals and are out of phase by 45 degrees with the feed ports.

In accordance with the invention, the tubular part 28 also comprises a restrictor port 52 which extends from a point roughly two-thirds along the length of one (or more) of the return ports 50 to a point on the outer surface of the tubular part 28 on side of the second check valve and adjacent to the second seal 31. The restrictor port 52 is inclined at a similar angle to the axis of the tubular part 28 as the feed ports 34 and return ports 50, albeit in a different direction. The restrictor port 52 is out of phase by 45 degrees with the feed ports.

When the tubular part 28 is installed in chamber 21, the second annular wall 42 abuts against a shoulder 56, ensuring a clearance between the lower end of the tubular part 28 and the inner chamber 21 of the housing 14. The cap part 19 is then fitted onto the housing part 18. When the tubular part 28 is installed in the chamber 21, and the cap part 19 is fully secured onto the housing part 18, the tubular part abuts the cap part 19. A space defined by crenallations 54 on the end of the tubular part 28 allows fluid to pass from the first non-return valve 32 to the outlets 23 and 24. At the other end of the tubular part 28, a space between the end of tubular part and the housing part 18 allows fluid to pass from the inlet 22, via the feed ports 48, to the first non-return valve 32 and from the restrictor port 52 to the inlet 22. The second O-ring 46 seals between the tubular part 28 and the inner chamber 21 of the housing 14, thereby stopping fluid from passing directly from the inlet 22 to the outlets 23, 24 and vice versa. The return ports 50 allow fluid to flow from the chamber outlets 23, 24 to the second non-return valve 33. The restrictor port 52 exit is at the side of the seal 46 of the inlet 22, so that fluid can flow from the outlets 23, 24 to the inlet 22 via the restrictor port.

The assembly 12 shown in FIGS. 1 to 6 is installed in the feed line from the master cylinder 11 at screw threaded portions 58, 60 and 62, and is intended to replace the tee-piece normally fitted to supply each front caliper 1. It can be seen that one outlet supplies one brake caliper, including both of its sides by way of a cross caliper bridge, and the other outlet supplies another brake caliper (shown schematically by a box referenced 2), although variations to the arrangement shown are possible.

It will be noted that both check valves 32, 33 are contained within a capsule. Capsules are easily changed to enable fitment of valves with different pressure ratings to suit the requirements of different vehicles.

The assembly 12 allows fluid to flow freely from the master cylinder to the brake caliper, with restricted flow in the reverse direction when pressure has decayed to a predetermined value. When a knock-off event occurs, the restricted reverse flow prevents displacement of a large volume of fluid, or at least limits displacement.

1. As the driver presses the brake pedal, pressure and fluid volume are delivered from the master cylinder 11 through a number of feed ports 48, opening the brake on check valve 32 at a pre-determined pressure and feeding the bores 2 in the left hand and right hand calipers 1. The brake-off check valve 33 remains closed.

2. As the driver releases the pedal, pressure diminishes and fluid volume returns from the caliper 1 by the action of the caliper relaxing. The brake on check valve 32 closes and pressure and fluid volume pass through the return ports and the brake-off change over valve 33 opens at a pre-determined pressure, allowing the pressure to decay and fluid to be returned to the master cylinder 11.

3. When the pressure has decayed to a pre-determined value, e.g. two bar, the brake-off change over valve 33 closes. The remaining system pressure then dissipates to zero through the restrictor port 52 (or ports), resulting in no pressure being retained in the system.

4. When a knock-off event occurs, giving rise to a pressure of up to say 1.5 bar, the brake-off change over valve 33 remains closed and any volume of fluid being displaced must pass through the restrictor port 52 to reach the master cylinder 11. The restrictor port 52 is choked in these circumstances. Thus the reverse flow is restricted, preventing displacement of a large volume of fluid and limiting the severity of knock-off.

In another embodiment of the invention, the device could be mounted in-line as shown in FIG. 7. Referring to FIG. 7, in another embodiment of the invention a brake fluid valve assembly 70 has a different type of housing. In particular, the T-shaped housing part is replaced by a cup-like housing part. A similar tubular part and check valve arrangement is arranged therein. Also, instead of the cap-like housing part, there is provided a cap with a bore 72. Therefore the brake fluid valve assembly in FIG. 7 has a single inlet and a single outlet as opposed to the single inlet and dual outlet arrangement shown in the previous embodiment.

In yet another embodiment of the invention, shown in FIG. 8, a brake fluid valve assembly 100 comprises a first brake fluid line 102 and a separate second brake fluid line 104 going respectively, from cylinder 11 to caliper 2 and from caliper 2 to cylinder 11. The first brake fluid line 102 comprises a first (brake on) non-return valve 106 and the second brake fluid line 104 comprises a second (brake off) non-return valve 108. The second (brake off) non-return valve 108 is like the second non-return valve 33, but with an integral return port (like 50) and restrictor port (like 52) thus enabling fluid to bypass the second (brake off) non-return valve 108.

Referring to FIG. 9, in a development of the embodiment shown in FIG. 8, a brake fluid valve assembly 110 comprises a second (brake off) non-return valve 112 without the return port and restrictor port. Instead, the assembly 110 comprises a third brake fluid line 114 with a restrictor port 116, separate to the first brake fluid line 102 and the separate second brake fluid line 104.

The size of the restrictor port, and therefore speed of pressure dissipation, could be adjusted by the inclusion of a needle valve. The needle valve allows tuning of the maximum fluid flow rate through the restrictor port. In that way, the assembly 12 can be adjusted prior to installation for different track conditions where knock-off events of different magnitude might occur.

The restrictor port could be incorporated into the brake-off change over valve.

The device can be integral with a master cylinder, brake caliper or another valve assembly within the brake fluid system, such as ABS, ESP.

The device can be constructed from a variety of materials.

1. A brake fluid valve assembly comprising a first fluid flow path means and a second fluid flow path means, each fluid flow path means for allowing brake fluid to flow in a direction from a caliper towards a master cylinder, the second fluid flow path means defining a minimum cross sectional area which is smaller than the minimum cross sectional area of the first fluid flow path means, the assembly being configured so that when brake fluid pressure is above a predetermined value, fluid can pass along the first fluid flow path means, and when brake fluid pressure drops below the predetermined value, the first fluid flow path means is arranged to close and fluid can pass only along the second fluid flow path, so as to restrict the maximum possible flow rate of fluid in a direction from a caliper towards a master cylinder.

2. A brake fluid valve assembly according to claim 1, wherein, when the brake fluid pressure is above the predetermined value, the second fluid flow path means is part of the first fluid flow path means.

3. A brake fluid valve assembly according to claim 1, wherein the first fluid flow path means comprises a plurality of paths for ducting fluid in parallel.

4. A brake fluid valve assembly according to claim 3, wherein one path of the first fluid flow path means has a different minimum cross sectional area from another path of the first fluid flow path means.

5. A brake fluid valve assembly according to claim 3, wherein one path of the first fluid flow path means has the same minimum cross sectional area as another path of the first fluid flow path means.

6. A brake fluid valve assembly according to claim 5, wherein all of the paths of the first fluid flow path means have the same minimum cross sectional area.

7. A brake fluid valve assembly according to claim 3, wherein at least one of the paths of the first fluid flow path has a larger minimum cross sectional area than the minimum cross sectional area of the second fluid flow path.

8. A brake fluid valve assembly according to claim 3, wherein a plurality of the paths of the first fluid flow path have a larger minimum cross sectional area than the minimum cross sectional area of the second fluid flow path.

9. A brake fluid valve assembly according to claim 3, wherein each of the paths have a larger minimum cross sectional area than the minimum cross sectional area of the second fluid flow path.

10. A brake fluid valve assembly according to claim 3, wherein at least one of the paths has a smaller minimum cross sectional area than the minimum cross sectional area of the second fluid flow path.

11. A brake fluid valve assembly according to claim 3, wherein a plurality of the paths have a smaller minimum cross sectional area than the minimum cross sectional area of the second fluid flow path.

12. A brake fluid valve assembly according to claim 3, wherein each of the paths have a smaller minimum cross sectional area than the minimum cross sectional area of the second fluid flow path.

13. A brake fluid valve assembly according to claim 3, wherein at least one of the paths has the same minimum cross sectional area as the minimum cross sectional area of the second fluid flow path.

14. A brake fluid valve assembly according to claim 3, wherein a plurality of the paths have the same minimum cross sectional area as the minimum cross sectional area of the second fluid flow path.

15. A brake fluid valve assembly according to claim 3, wherein each of the paths have the same minimum cross sectional area as the minimum cross sectional area of the second fluid flow path.

16. A brake fluid valve assembly according to claim 1, wherein the second fluid flow path means comprises a plurality of paths.

17. A brake fluid valve assembly according to claim 1, wherein the second fluid flow path means comprises a single path.

18. A brake fluid valve assembly according to claim 1, wherein, above the pre-determined pressure, the first fluid flow path means is arranged so that at least part of the fluid flowing therethrough is unchoked.

19. A brake fluid valve assembly according to claim 1, wherein, below the predetermined pressure, the second fluid flow path is arranged so that at least part of the fluid flowing therethrough is choked.

20. A brake fluid valve assembly according to claim 1, wherein the assembly comprises a non-return valve which defines the first fluid flow path.

21. A brake fluid valve assembly according to claim 20, wherein the non-return valve also defines the second fluid flow path.

22. A brake fluid valve assembly according to claim 20, wherein the second fluid flow path is arranged to allow fluid to by-pass the non-return valve and the first fluid flow path.

23. A brake fluid valve assembly according to claim 1, wherein the first fluid flow path is arranged to close when brake fluid pressure is between 0 and 6 bar.

24. A brake fluid valve assembly according to claim 23, wherein the first fluid flow path is arranged to close when brake fluid pressure drops below a pressure of about two bar.

25. A brake fluid valve assembly according to claim 1, wherein the size of the minimum area of the second fluid flow path is variable.

26. A brake fluid valve assembly according to claim 25, wherein the second fluid flow path comprises a needle valve arranged to vary its size.

27. A brake fluid valve assembly according to claim 1, wherein the second fluid flow path comprises a restrictor port.

28. A brake fluid valve assembly according to claim 1, wherein the second fluid flow path comprises a plurality of restrictor ports.

29. A brake fluid valve assembly according to claim 1, wherein the first fluid flow path comprises a plurality of return ports.

30. A brake fluid valve assembly according to claims 28, wherein at least one return port has a restrictor port associated with it.

31. A brake fluid valve assembly according to claims 28, wherein each return port has a restrictor port associated with it.

32. A brake fluid valve assembly according to claim 1, wherein the assembly comprises a second non-return valve for letting fluid flow from a master cylinder towards a caliper to apply a brake.

33. A brake fluid valve assembly according to claim 32, wherein the assembly comprises a housing defining an inner chamber, the first non-return valve and the second non-return valve being arranged in the chamber, the housing defining an inlet and an outlet.

34. A brake fluid valve assembly according to claim 33, wherein the assembly comprises at least one restrictor port arranged between the outlet and the second non-return valve.

35. A brake fluid valve assembly according to claim 33, wherein the assembly comprises a single restrictor port arranged between the outlet and the second non-return valve.

36. A brake fluid valve assembly according to claim 33, wherein the assembly comprises a return port arranged to allow fluid to flow from the outlet to the second non-return valve.

37. A brake fluid valve assembly according to claim 33, wherein the assembly comprises a plurality of return ports arranged to allow fluid to flow from the outlet to the first non-return valve.

38. A brake fluid valve assembly according to claim 33, wherein the assembly comprises a plurality of feed ports arranged to allow fluid to flow from the inlet to the second non-return valve.

39. A brake fluid valve assembly according to claim 33, wherein the assembly comprises a restrictor port being arranged between two feed ports.

40. A brake fluid valve assembly according to claim 39, wherein the assembly comprises a restrictor port arranged midway between two feed ports.

41. A brake fluid valve assembly according to claim 1, wherein the brake fluid valve assembly is enclosed in a capsule.

42. A brake fluid valve assembly substantially as described herein with reference to the appropriate accompanying drawings.

43. A master cylinder comprising a brake fluid valve assembly according to claim 1.

44. A brake caliper comprising a brake fluid valve assembly according to claim 1.

45. A brake fluid control circuit comprising a brake fluid valve assembly according to claim 1.

46. A vehicle comprising a brake fluid valve assembly or master cylinder or brake caliper according to claim 1.
